(19) United States
(12) Patent Application Publication
(10) Pub. No.: US 2021/0244182 A1
(43) Pub. Date: Aug. 12, 2021

(54) Flame Resistant Work Site Cabinet

(71) Applicant: APEX BRANDS, INC., Apex, NC (US)

(72) Inventors: Michael Taber, Jonesboro, AR (US); Jason Mars, Jonesboro, AR (US); William Tyer, Jonesboro, AR (US)

(21) Appl. No.: 17/259,312

(22) PCT Filed: Sep. 4, 2019
(86) PCT No.: PCT/US2019/049491

§ 371 Date: Jan. 11, 2021

Related U.S. Application Data
(60) Provisional application No. 62/728,343, filed on Sep. 7, 2018.

(51) Int. Cl. A47B 81/00; E05G 1/024

(52) U.S. Cl. CPC A47B 81/00; E05Y 2900/21; E05Y 2800/416; E05G 1/024

(57) ABSTRACT

A flammable liquid storage cabinet may include a base portion, two opposing sidewalls extending substantially perpendicularly upward from the base portion, a rear wall extending substantially perpendicularly upward from the base portion between respective ends of the sidewalls, a top portion disposed opposite the base portion to cover a top of the sidewalls and the rear wall and define a receiving space in the storage cabinet for receiving a flammable liquid container, and a door assembly disposed opposite the rear wall. Each of the sidewalls, the rear wall, and the door assembly may include a double walled structure having a loose granular insulating material poured therein

### CROSS REFERENCE TO RELATED APPLICATIONS

This application claims priority to U.S. application No. 62/728,343 filed Sep. 7, 2018, the entire contents of which are hereby incorporated by reference in its entirety.

### TECHNICAL FIELD

Example embodiments generally relate to containers for storing flammable liquids and, in particular, relate to a flame resistant cabinet that employs insulation materials that provide superior flame resistance, and a method of making the same.

### BACKGROUND

Underwriters Laboratory (UL) is accredited by the American National Standards Institute (ANSI) in the US, and by similar organizations elsewhere, to develop standards for products in order to promote public safety. As such, UL engages in rigorous testing and research to develop performance standards that, when met, provide consumers with an assurance that the corresponding product is designed, tested, and in compliance with stringent quality safety standards.

Aerosols, fuels and other flammable liquids are often necessary to be stored by either business owners or consumers. Some jurisdictions may require storage of such flammable liquids within certain approved cabinets. These cabinets, however, may not meet the requirements necessary to pass UL standards. Due to the relatively strenuous requirements of the UL standards, passing them may require additional cost to manufacturers to meet the standards. A more costly container may cause some consumers to avoid incurring the cost and instead opt for a cheaper, and consequently potentially less safe, container.

Accordingly, it may be desirable to provide a flammable liquid container that is designed to relatively high performance standards without correspondingly increasing costs to the point that the container becomes prohibitively expensive.

### BRIEF SUMMARY OF SOME EXAMPLES

In an example embodiment, a flammable liquid storage cabinet is provided. The storage cabinet may include a base portion, two opposing sidewalls extending substantially perpendicularly upward from the base portion, a rear wall extending substantially perpendicularly upward from the base portion between respective ends of the sidewalls, a top portion disposed opposite the base portion to cover a top of the sidewalls and the rear wall and define a receiving space in the storage cabinet for receiving a flammable liquid container, and a door assembly disposed opposite the rear wall. Each of the sidewalls, the rear wall, and the door assembly may include a double walled structure having a loose granular insulating material poured therein.

In another example embodiment, a method of manufacturing a flammable liquid storage cabinet is provided. The method may include forming two opposing sidewalls extending spaced apart from each other in substantially parallel planes and a rear wall extending substantially between respective ends of the sidewalls such that each of the sidewalls and the rear wall are double walls defining an enclosable void space, forming a door assembly as a double walled door defining a second enclosable void space, pouring a loose granular insulating material into the enclosable void space of the sidewalls and the rear wall, and pouring the insulating material into the second enclosable void space of the door assembly.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1A illustrates a front perspective view of a flammable liquid storage cabinet with doors closed according to an example embodiment;

FIG. 1B illustrates a front perspective view of the storage cabinet with doors open according to an example embodiment;

FIG. 2A illustrates a top view of the storage cabinet with doors open according to an example embodiment;

FIG. 2B illustrates a front view of the storage cabinet with doors open according to an example embodiment;

FIG. 3 illustrates an exploded view of the storage cabinet according to an example embodiment;

FIG. 4A illustrates a cross section view of either a door, a sidewall or a rear wall of the storage cabinet to illustrate a void space between sheets forming the double walled structures thereof according to an example embodiment;

FIG. 4B illustrates the void space of FIG. 4A after being filled with a loose granular insulating material according to an example embodiment;

FIG. 5 illustrates a perspective view of a snap plug according to another example embodiment; and

FIG. 6 illustrates a method of manufacturing a flammable liquid storage cabinet according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

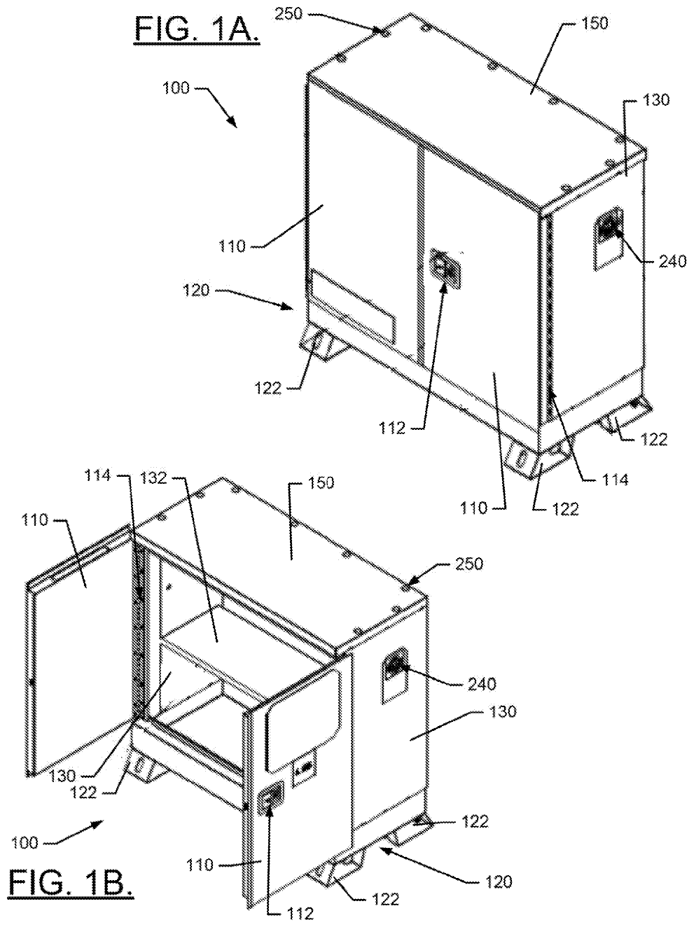

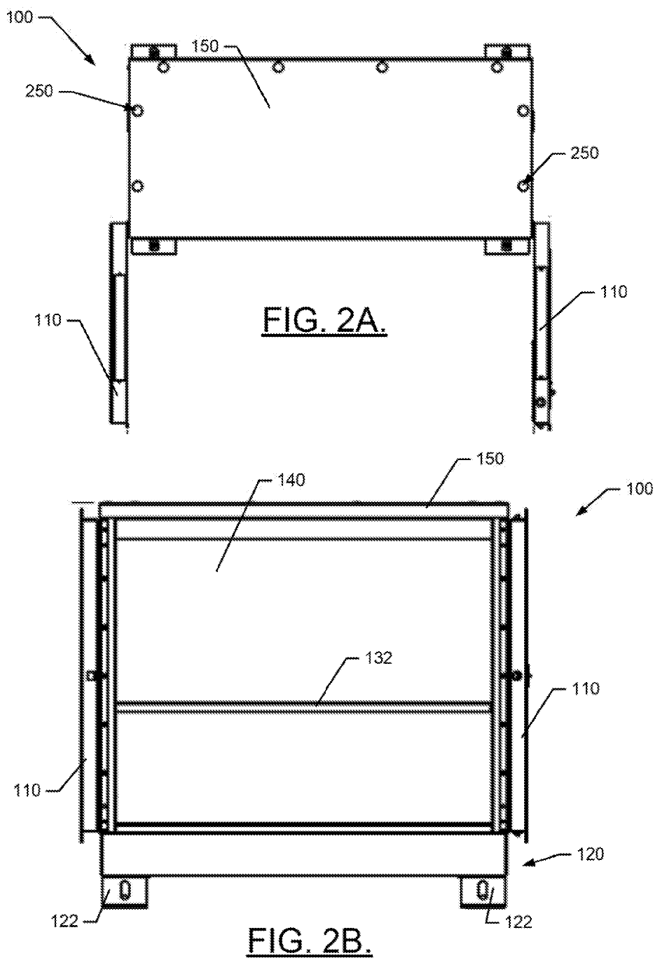

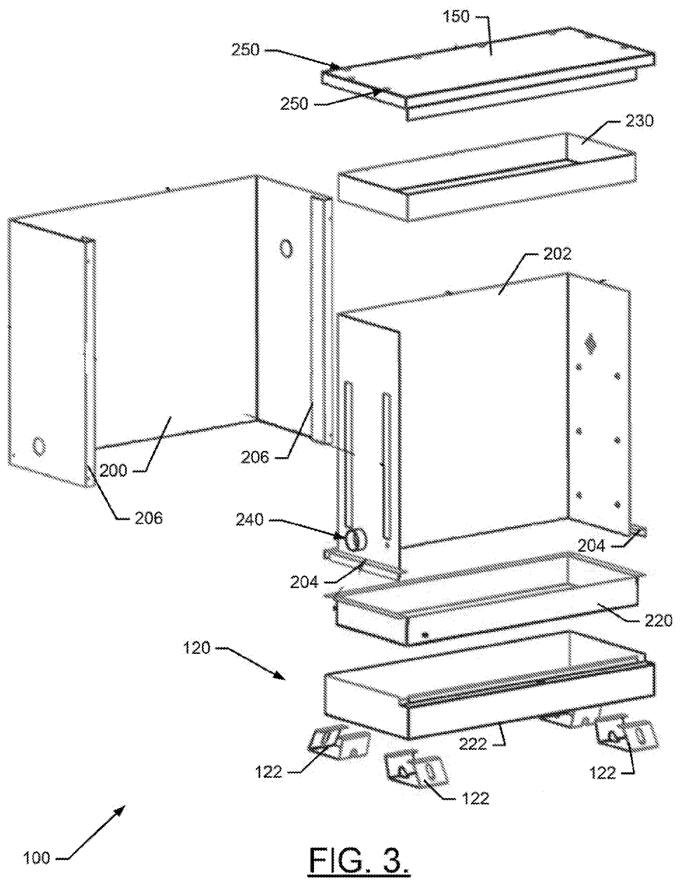

As indicated above, some example embodiments may relate to the provision of a flame resistant cabinet for flammable liquid storage. Moreover, example embodiments may provide high performance without a corresponding high cost. In this regard, FIGS. 1A and 1B illustrate perspective view of a flammable liquid storage cabinet 100 with doors 110 closed and open, respectively. FIGS. 2A and 2B show top and front views, respectively, of the storage cabinet 100 with the doors 110 open. At least one of the doors 110 may include a latch assembly 112 configured to enable the doors 110 to be alternately opened and closed and, in some cases, locked. The doors 110 may be operably coupled to the storage cabinet 100 via a hinge assembly 114. Of note, although the example shown includes two doors 110 of substantially equal size, other door arrangements are also possible. For example, a single door, two doors of unequal size, or various other options for accessing the storage cabinet 100 are also possible.

The storage cabinet 100 includes a base portion 120 which is supported by feet 122. The feet 122 may be adjustable in length for leveling purposes in some cases. The storage cabinet 100 may also include sidewalls 130, a rear wall 140 and a top portion 150. The sidewalls 130 may engage the top portion 150 and the base portion 120 at opposite ends thereof. Meanwhile, a rear edge of each of the sidewalls 130 may engage opposing sides of the rear wall 140, and the doors 110 may be operably coupled to the front edge of the sidewalls 130 (e.g., via the hinge assembly 114). The top and bottom of the rear wall 140 may engage the top portion 150 and base portion 120, respectively. Accordingly, when the doors 110 are in the closed position (as shown in FIG. 1A), the storage cabinet 100 may define a secure and fully enclosed container inside which flammable liquids may be stored. When the doors 110 are in the open position (as shown in FIG. 1B, the storage cabinet 100 may be loaded with one or more flammable liquid containers (not shown).

In some cases, one or more instances of a shelf 132 may be provided within the storage cabinet 100. The shelf 132 may be permanent or removable. To facilitate removal of the shelf 132, for example, the sidewalls 130 of some embodiments may be provided with repositionable shelf clips that can be positioned to support the shelf 132 at selectable heights within the storage cabinet 100. Alternatively, permanent or fixed shelf supports may be formed in (or permanently attached to) the sidewalls 130 at various heights to enable the consumer to select a desired shelf height and install the shelf 132 accordingly.

FIG. 3 illustrates an exploded view of the storage cabinet 100 with the doors 110 removed. As can be appreciated from FIGS. 1A, 1B, 2A, 2B and 3, the sidewalls 130 and the rear wall 140 are each double walls. In other words, the sidewalls 130 and rear wall 140 are each formed by an outer sheet 200 and an inner sheet 202 that correspond to each other, but are spaced apart from each other. The inner sheet 202 of this example includes a skirt 204 that extends around a bottom portion of the outer periphery of the inner sheet 202. The outer sheet 200 of this example includes a spacer 206 on each of the forward edges of the outer sheet 200. The spacer 206 have have an L shape such that each spacer 206 initially extends inwardly away from one of the forward edges and toward the other spacer 206. The spacer 206 then extends rearward (i.e., toward the rear wall 140). The inner sheet 202 can then be attached to the rearward extending portion of the spacer 206 in order to define a void space between the inner sheet 202 and the outer sheet 200 that is about equal to the distance that each spacer 206 extends inwardly away from its respective forward edge of the outer sheet 200. In some cases, a width of the spacer 206 may be about equal to a width of the skirt 204. Thus, when assembled, the inner sheet 202, the outer sheet 200, the skirt 204 and the spacer 206 may effectively define a container with no top. A width of the container that is defined (i.e., the void space) may be substantially constant at all points between the inner sheet 202 and the outer sheet 200. In some cases, the width may be greater than about 1.5 inches (e.g., about 1.6 inches). However, widths between 1 and 2 inches are possible in alternative embodiments.

The skirt 204 may rest on edges of a sump pan 220. The sump pan 220 may be part of the base portion 120. The sump pan 220 may be configured to contain any leakage from containers that are stored within the storage cabinet 100. The sump 220 may be a single piece tub, and may be configured to hold up to 5 gallons of fluid (leakage) without exceeding 2 inches in depth of the fluid. The sump 220 may be either removable from or integral in the storage cabinet 100. The top portion 150 may sit atop the upper edges of each of the inner sheet 202 and the outer sheet 200. However, in some cases, a frame member 230 may be provided to further support the inner sheet 202, outer sheet 200 and the top portion 150.

Although the void space defined in the sidewalls 130 and the rear wall 140 are shown to be a single continuous space in this example, it should be appreciated that frame members or other dividing structures could divide the void space into separate compartments in some cases. For example, a frame member could be provided at the intersection of the rear wall 140 with each of the sidewalls 130 to divide the void space into three separate and distinct void spaces.

As noted above, the inner sheet 202, the outer sheet 200, the skirt 204 and the spacer 206 may define a container with no top. Once the top portion 150 is attached, the container may also include a top, and a fully enclosed void space may be defined. However, there may be some penetrations into or through this void space. For example, one or more vents 240 may be provided in the sidewalls 130, and the vents 240 may necessarily pass through the inner sheet 202 and outer sheet 200. From the perspective of the void space defined between the inner sheet 202 and the outer sheet 200, the vents 240 form obstructions that pass entirely through the void space. In an example embodiment, one or more fill openings 250 may also be provided through the top portion 150 proximate to edges thereof In this regard, the fill openings 250 may be aligned with the void space formed between the inner sheet 202 and the outer sheet 200. The fill openings 250 may be formed by drilling, stamping, punching, or any other desirable method, and the fill openings 250 may allow access to the void space defined between the inner sheet 202 and the outer sheet 200.

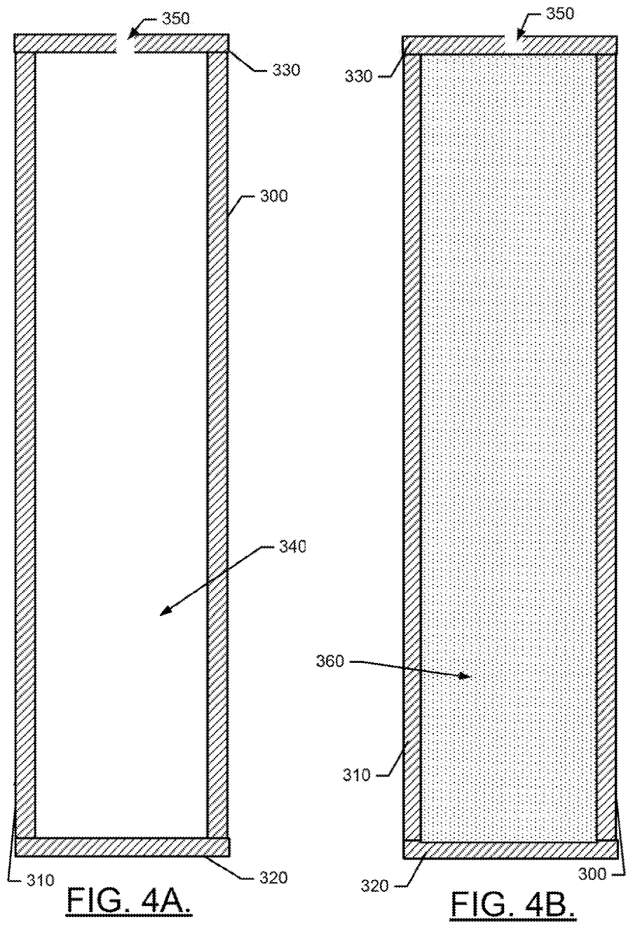

The doors 110 may be formed similarly to the structures described above for the formation of the sidewalls 130 and rear wall 140. In this regard, the doors 110 may also be structured as doubled walled doors that form a void space, and that have a fill opening at a top portion thereof. Accordingly, the generic structure of FIGS. 4A and 4B can be said to apply to both the doors 110 and the sidewalls 130 and rear wall 140. In this regard, FIGS. 4A and 4B illustrate cross section views of either a door 110, a sidewall 130, or a rear wall 140 taken along a vertical plane that passes through a fill opening before filling (FIG. 4A) and after filling (FIG. 4B) with an insulating material.

As shown in FIG. 4, an inner sheet 300 and outer sheet 310 may be spaced apart from each other and extend substantially parallel to each other. The inner sheet 300 and outer sheet 310 may correspond to the inner sheet 202 and outer sheet 200 described above, or to the inner and outer walls of the door 110. A bottom sheet 320 may be defined between the inner sheet 300 and outer sheet 310, and may extend in a plane perpendicular to the planes in which the inner sheet 300 and outer sheet 310 lie. The bottom sheet 320 may correspond to the skirt 204 or to the bottom sheet that forms a bottom of one of the doors 110. A top sheet 330 (e.g., top portion 150 or a top wall of the door 110) may extend parallel to, and spaced apart from the bottom sheet 320 to define an enclosure inside which void space 340 is formed in the manner described above. For the doors 110 lateral sidewalls may also be present, and for the sidewalls 130, the spacers 206 may bound the edges that are not shown in the cross section view. A width of each of the sheets may be at least about 0.04 inches. As noted above, the void space 340 may be at least 1.5 inches wide. In some cases, the sidewalls 130 and rear wall 140 may have a void space that is about 1.6 inches wide, and the doors 110 may have a void space that is about 1.7 inches wide.

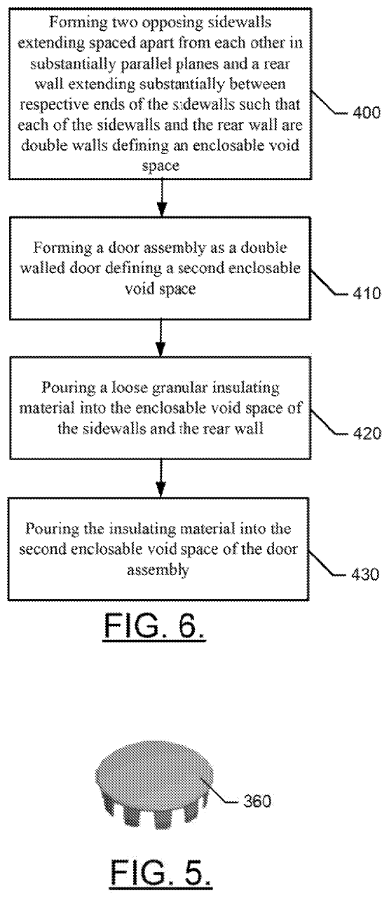

Fill opening 350 may be provided in the top sheet 330 to enable access to the void space 340. In an example embodiment, a loose granular insulating material 360 may be poured into the void space 340 through the fill opening 350 to fill the void space 340. The insulating material 360 may be loose and granular to allow flowing of the insulating materials 360 in order to fill any corners and also flow into any gaps formed by other obstructions (e.g., the vents 240). After the insulating material 360 completely (or nearly completely) fills the void space 340, the fill opening 350 may be capped by inserting a snap plug 360 (see FIG. 5) into the fill opening 350. The snap plug 360 may be made of metallic (or other rigid) material that can be pushed or hammered into the fill opening 350 to form a snap fit therewith, and effectively seal the void space 340.

By employing the insulating material 360, it may be possible to provide effective insulation to the storage cabinet 100 and to enable the storage cabinet 100 to withstand very high temperatures that may result from a flammable liquid stored therein catching fire. Moreover, if insulating material 360 is chosen to have specific desirable qualities, the performance of the storage cabinet 100 may be improved while avoiding significant increases in cost, as mentioned above. Accordingly, some example embodiments may employ perlite (i.e., loose granular perlite) as the insulating material 360. In particular, the perlite may be perlite that is considered to be horticulture grade perlite. Additionally or alternatively, the perlite may be provided to have a maximum particle dimension of 0.5 inches. The bulk density of the perlite may be selected to be in a range of about 5 to 8 lbs/ft³ with an effective density of about 2.5 to 3.3 lbs/gal. Perlite having the above noted characteristics may be fine enough to enable effective filling, but course enough to enable effective pouring. As a result of using perlite as the insulating material 360, the storage cabinet 100 may be enabled to limit the internal temperature of the storage cabinet 100 to under 325 degrees when tested with the standard for safety of flammable liquid storage cabinets defined in UL 1275 (which is incorporated herein by reference). In particular, the UL 1275 standard, third edition, as designated on Feb. 26, 2010.

FIG. 6 illustrates a block diagram of a method of manufacturing a flammable liquid storage cabinet according to an example embodiment. The method may include forming two opposing sidewalls extending spaced apart from each other in substantially parallel planes and a rear wall extending substantially between respective ends of the sidewalls such that each of the sidewalls and the rear wall are double walls defining an enclosable void space at operation 400. The method may further include forming a door assembly as a double walled door defining a second enclosable void space at operation 410 and pouring a loose granular insulating material into the enclosable void space of the sidewalls and the rear wall at operation 420. The method may further include pouring the insulating material into the second enclosable void space of the door assembly at operation 430. Assembly of the door assembly to the sidewalls together with a base portion and top portion may be understood to be part of the assembly that precedes pouring since the pouring typically occurs through fill openings in the top portion. Of note, operations 400 and 410 can be performed in any order, and the same is true of operations 420 and 430. Moreover, operations 400 and 420 could each be performed before operations 410 and 430, or that order could be reversed.

In an example embodiment, a flammable liquid storage cabinet is provided. The storage cabinet may include a base portion, two opposing sidewalls extending substantially perpendicularly upward from the base portion, a rear wall extending substantially perpendicularly upward from the base portion between respective ends of the sidewalls, a top portion disposed opposite the base portion to cover a top of the sidewalls and the rear wall and define a receiving space in the storage cabinet for receiving a flammable liquid container, and a door assembly disposed opposite the rear wall. Each of the sidewalls, the rear wall, and the door assembly may include a double walled structure having a loose granular insulating material poured therein.

The storage cabinet may be modified or augmented with additional (optional) features. For example, in some cases, the insulating material may be perlite. The perlite may be horticulture grade perlite and/or may have a maximum particle dimension of about 0.5 inches, have a bulk density in a range of about 5 to 8 lbs/ft³, and have an effective density of about 2.5 to 3.3 lbs/gal. In an example embodiment, the insulating material (i.e., the perlite) may be configured to limit the internal temperature of the storage cabinet to under 325 degrees when tested with a standard for safety of flammable liquid storage cabinets defined in UL 1275. In some cases, the rear wall and the sidewalls may be defined by an inner sheet and an outer sheet defining a void space therebetween, and the insulating material may be disposed in the void space by pouring through a fill opening defined in the top portion in alignment with the void space. Similarly, the door assembly may include at least one door that is defined by an inner sheet and an outer sheet defining a void space therebetween, and the insulating material is disposed in the void space by pouring through a fill opening defined in a top of the door. In either case (or both cases), the void space may be at least 1.5 inches thick. Additionally, responsive to filling of the void space with the insulating material, a snap plug may disposed in the fill opening to seal the perlite in the void space. In an example embodiment, the base portion may further include a sump pan. The sump pan may be a single piece tub configured to hold up to 5 gallons of fluid without a depth of the fluid exceeding 2 inches. In some cases, the sump pan may either be removable from the storage cabinet or integrated into the base portion of the storage cabinet. In an example embodiment, the sidewalls and the rear wall may each be formed by a common inner sheet and a common outer sheet defining a single continuous void space therebetween.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A flammable liquid storage cabinet comprising:
a base portion;
two opposing sidewalls extending substantially perpendicularly upward from the base portion;
a rear wall extending substantially perpendicularly upward from the base portion between respective ends of the sidewalls;
a top portion disposed opposite the base portion to cover a top of the sidewalls and the rear wall and define a receiving space in the storage cabinet for receiving a flammable liquid container; and
a door assembly disposed opposite the rear wall,
wherein each of the sidewalls, the rear wall, and the door assembly comprises a double walled structure having a loose granular insulating material poured therein,
wherein the rear wall and the sidewalls are defined by an inner sheet and an outer sheet defining a void space therebetween, and
wherein the insulating material is disposed in the void space by pouring through a fill opening defined in the top portion in alignment with the void space.

2. The storage cabinet of claim 1, wherein the insulating material comprises perlite.

3. The storage cabinet of claim 2, wherein the perlite has a maximum particle dimension of about 0.5 inches.

4. The storage cabinet of claim 2, wherein the perlite has a bulk density in a range of about 5 to 8 lbs/ft³ and an effective density of about 2.5 to 3.3 lbs/gal.

5. The storage cabinet of claim 2, wherein the insulating material is configured to limit the internal temperature of the storage cabinet to under 325 degrees when tested with a standard for safety of flammable liquid storage cabinets defined in UL 1275.

6. (canceled)

7. The storage cabinet of claim 1, wherein the void space is at least 1.5 inches thick.

8. The storage cabinet of claim 1, wherein responsive to filling of the void space with the insulating material, a snap plug is disposed in the fill opening.

9. A flammable liquid storage cabinet comprising:
a base portion;
two opposing sidewalls extending substantially perpendicularly upward from the base portion;
a rear wall extending substantially perpendicularly upward from the base portion between respective ends of the sidewalls;
a top portion disposed opposite the base portion to cover a top of the sidewalls and the rear wall and define a receiving space in the storage cabinet for receiving a flammable liquid container; and
a door assembly disposed opposite the rear wall,
wherein each of the sidewalls, the rear wall, and the door assembly comprises a double walled structure having a loose granular insulating material poured therein,
wherein the door assembly comprises at least one door that is defined by an inner sheet and an outer sheet defining a void space therebetween, and
wherein the insulating material is disposed in the void space by pouring through a fill opening defined in a top of the door.

10. The storage cabinet of claim 9, wherein the void space is at least 1.5 inches thick.

11. The storage cabinet of claim 9, wherein responsive to filling of the void space with the insulating material, a snap plug is disposed in the fill opening.

12. The storage cabinet of claim 1, wherein the base portion further comprises a sump pan.

13. The storage cabinet of claim 12, wherein the sump pan is a single piece tub configured to hold up to 5 gallons of fluid without a depth of the fluid exceeding 2 inches.

14. The storage cabinet of claim 12, wherein the sump pan is removable from the storage cabinet.

15. The storage cabinet of claim 12, wherein the sump pan is integrated into the base portion of the storage cabinet.

16. The storage cabinet of claim 1, wherein the sidewalls and the rear wall are each formed by a common inner sheet and a common outer sheet defining a single continuous void space therebetween.

17. A method of manufacturing a flammable liquid storage cabinet, the method comprising:
forming two opposing sidewalls extending spaced apart from each other in substantially parallel planes and a rear wall extending substantially between respective ends of the sidewalls such that each of the sidewalls and the rear wall are double walls defining an enclosable void space;
forming a door assembly as a double walled door defining a second enclosable void space;
pouring a loose granular insulating material into the enclosable void space of the sidewalls and the rear wall;
pouring the insulating material into the second enclosable void space of the door assembly; and
installing a plug into a fill opening through which the insulating material is poured,
wherein pouring the insulating material comprises pouring perlite.

18. (canceled)

19. The method of claim 17, wherein the perlite has a maximum particle dimension of about 0.5 inches, a bulk density in a range of about 5 to 8 lbs/ft³ and an effective density of about 2.5 to 3.3 lbs/gal.

20. (canceled)
